(19) United States
(12) Patent Application Publication
(10) Pub. No.: US 2024/0403193 A1
(43) Pub. Date: Dec. 5, 2024

(54) ON-CHIP (IN-SYSTEM) TRIGGERING OF LOGIC ANALYZER

(71) Applicant: XILINX, INC., San Jose, CA (US)

(72) Inventor: Prashant MEHTA, Thornton, CO (US)

(21) Appl. No.: 18/203,607

(22) Filed: May 30, 2023

(51) Int. Cl. G06F 11/36

(52) U.S. Cl. CPC G06F 11/3656; G06F 11/3644

(57) ABSTRACT

An integrated circuit (IC) device includes functional circuitry and data capture circuitry that stores a state of the functional circuitry in a buffer and outputs contents of the buffer to an external device based on a trigger. An embedded processor interacts with the functional circuitry based on a computer program, and initiates the trigger. The processor may initiate the trigger at a selectable break-point of the computer program and/or based on data generated by the functional circuitry. The processor may also output corresponding states of variables managed by the processor. The processor may initiate the trigger by asserting a predetermined value on a communication path between the processor and the functional circuitry, or over another communication path (e.g., an AXI debug hub) between the processor and the data capture circuitry. The processor may monitor/control the data capture circuitry through an API.

### TECHNICAL FIELD

Examples of the present disclosure generally relate to on-chip (in-system) triggering of a logic analyzer.

### BACKGROUND

An integrated circuit (IC) device may include functional circuitry and an embedded processor that interacts with the functional circuitry based on an embedded computer program. The IC device may further include data capture circuitry (e.g., logic analyzer circuitry) that captures and time-stamps states of internal signals of the functional circuitry in a buffer. The buffer may be relatively small, and the data capture circuitry may overwrite an older state of functional circuitry with a current state.

The data capture circuitry may be configurable to output contents of the buffer when the state of one or more of the internal signals of the functional circuitry match a predefined state. This may be useful for debugging an issue of the functional circuitry, if the state of the one or more of the internal signals, when the issue occurs, is known.

The embedded processor may execute the embedded computer program in a debugging mode, and may capture a state of variables managed by the embedded processor at points of interest of the embedded computer program. This may be useful to debug the embedded computer program.

There may be situations in which it is desirable to obtain states of the internal signals of the functional circuitry at a point of interest of the embedded computer program, such as when it is unknown whether an issue is due to the functional circuitry or the embedded computer program. Although a user may initiate an instantaneous trigger to the data capture circuitry at a point of interest of the embedded computer program, the data capture circuitry may overwrite a corresponding state of the functional circuitry before the data capture circuitry receives the trigger.

### SUMMARY

Techniques for on-chip (in-system) triggering of a logic analyzer are described. One example is an integrated circuit (IC) device that includes functional circuitry and a processor that interacts with the functional circuitry based on a computer program, and initiates a trigger. The IC device further includes data capture circuitry that stores a state of the functional circuitry in a buffer and outputs contents of the buffer to an external device based on the trigger.

Another example described herein is an IC device that includes functional circuitry and a processor that interacts with the functional circuitry based on a computer program, initiates a trigger, and outputs states of variables managed by the processor to an external device at a selectable break-point of the computer program. The IC device further includes data capture circuitry that stores a state of the functional circuitry in a buffer, and outputs contents of the buffer to the external device based on the trigger.

Another example described herein is an IC device that includes programmable logic that includes functional circuitry and data capture circuitry that stores a state of the functional circuitry in a buffer and outputs contents of the buffer to an external device based on a trigger. The IC device further includes a processor that interacts with the functional circuitry based on a computer program, and initiates the trigger.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of an integrated circuit (IC) device, including functional circuitry, an embedded processor, and data capture circuitry, according to an embodiment.

FIG. 2 is a block diagram of the IC device in which the functional circuitry and the data capture circuitry are provided in programmable logic (PL), according to an embodiment.

FIG. 3 is a block diagram of the IC device, further including a communication path between the processor and the data capture circuitry, according to an embodiment.

FIG. 4 is a block diagram of configurable circuitry, including an array of configurable or programmable circuit blocks or tiles, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe techniques for on-chip (in-system) triggering of a data capture circuitry (e.g., on-chip logic analyzer circuitry). Techniques for on-chip triggering of data capture circuitry may be useful to obtain a state of internal signals of functional circuitry corresponding to a point of interest of an embedded computer program, and/or for other purposes.

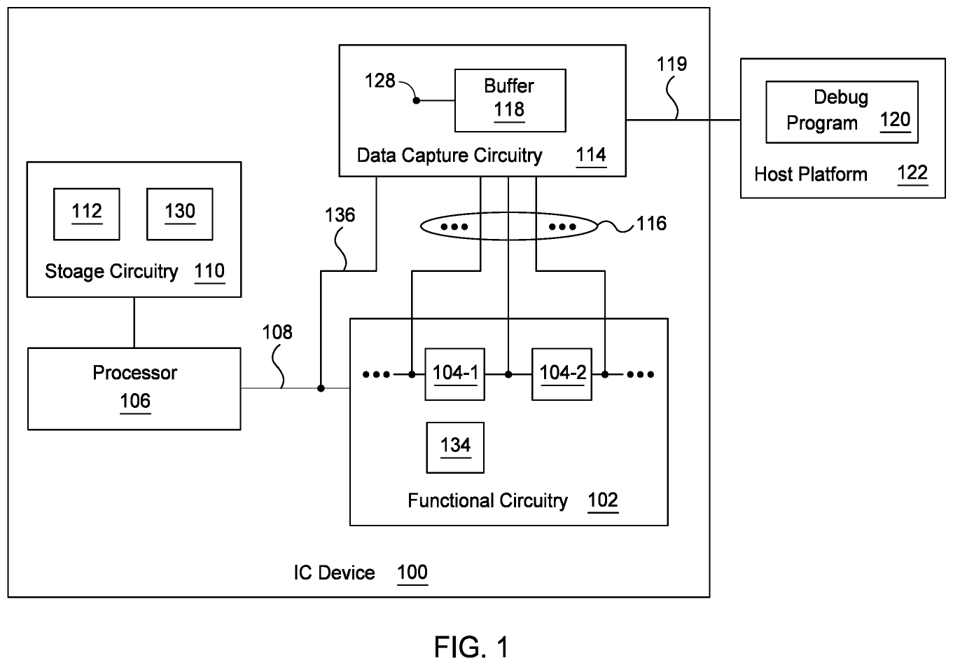

FIG. 1 is a block diagram of an integrated circuit (IC) device 100, according to an embodiment. IC device 100 includes functional circuitry 102, which may include one or more sub-systems, or blocks of circuitry, referred to herein as intellectual property (IP) blocks 104.

IC device 100 further includes an embedded processor 106 that interacts with functional circuitry 102 over a communication path 108 (e.g., a multi-bit bus). Processor 106 may provide data to functional circuitry 102 for processing by one or more of IP blocks 104, and/or may process data/signals generated by one or more of IP blocks 104.

In the example of FIG. 1, processor 106 interacts with functional circuitry 102 based on an embedded computer program, referred to herein as a functional computer program 112. Processor 106 also initiates a trigger 128 based on another embedded computer program, referred to herein as a trigger computer program 130, examples of which are provided further below.

IC device 100 may further include storage circuitry 110 (e.g., a non-transitory computer readable medium), that stores functional computer program 112, trigger computer program 130, and data. Storage circuitry 110 and/or computer programs stored therein may be referred to as firmware.

IC device 100 further includes data capture circuitry 114 that captures a state of functional circuitry 102 (e.g., internal signals/data, such as buffer/register contents, states at various nodes, and/or other signals/data) over one or more connections 116. Data capture circuitry 114 saves the state in a buffer 118, and outputs contents of buffer 118 based on trigger 128. Data capture circuitry 114 may output the contents of buffer 118 to a debug program 120 of a host platform 122 over an interface 119. Data capture circuitry 114 and host platform 122 may interface with one another based on a standard, such as a JTAG standard managed by a Joint Test Action Group. In an embodiment, data capture circuitry 114 repeatedly (e.g., periodically) captures the state of functional circuitry 102 in buffer 118. Buffer 118 may overwrite a prior state of functional circuitry 102 stored in buffer 118 with a current state of functional circuitry 102.

Data capture circuitry 114 may include an integrated logic analyzer (ILA) core that monitors functional circuitry 102. The ILA core may include Boolean trigger equations, and edge transition triggers. The ILA core may operate synchronously with functional circuitry 102. Any design clock constraints applied to functional circuitry 102 may also be applied to components of the ILA core. The ILA core may include multiple user-selectable probe ports, which may be combined into a single trigger condition. The ILA core may provide user-selectable trigger widths, data widths, and data depths. The ILA core may include an interface (e.g., based on a protocol such as an on-chip Advanced extensible Interface (AXI) protocol developed by ARM of Cambridge, England), to debug any debuggable interfaces of functional circuitry 102 (e.g., AXI4-MM and Stream interfaces of functional circuitry 102). The ILA core may permit user-selectable AXI4-MM channel debug and AXI Data/Address width selection. The ILA core may permit data and trigger probe selection and interface type selection. The ILA core may provide block random-access memory (BRAM) estimation. The ILA core may support AXI4-MM and AXI4-Stream protocol checking. The ILA core may include, without limitation, a AXI memory-mapped interface (e.g., AXI-MM), an AXI4-Lite control interface, and/or an AXI4-stream video interface.

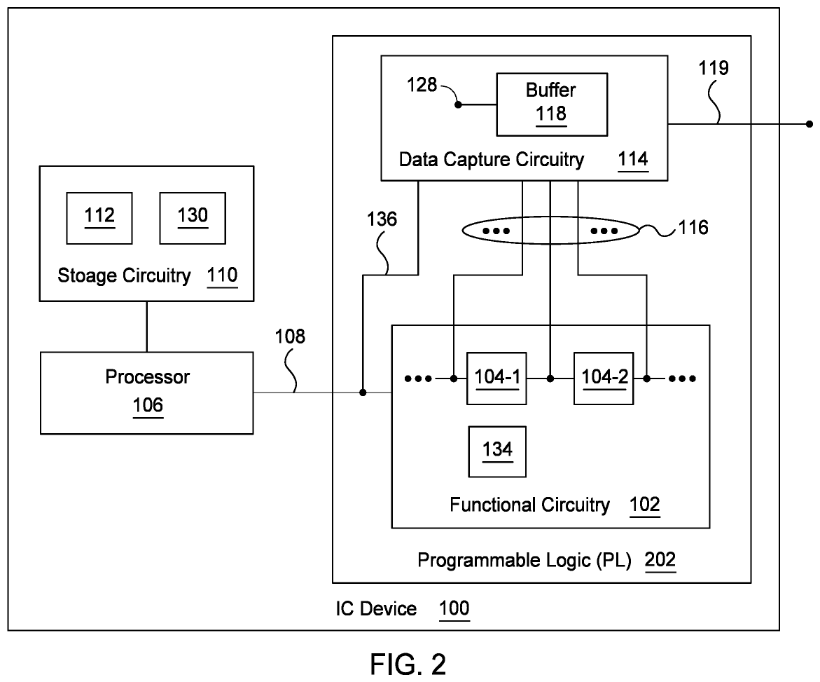

Functional circuitry 102 and/or data capture circuitry 114 may include fixed-function circuitry (e.g., application-specific integrated circuitry, or ASIC) and/or configurable circuitry, referred to herein as programmable logic (PL). FIG. 2 is a block diagram of IC device 100 in which functional circuitry 102 and data capture circuitry 114 are provided in PL 202, according to an embodiment.

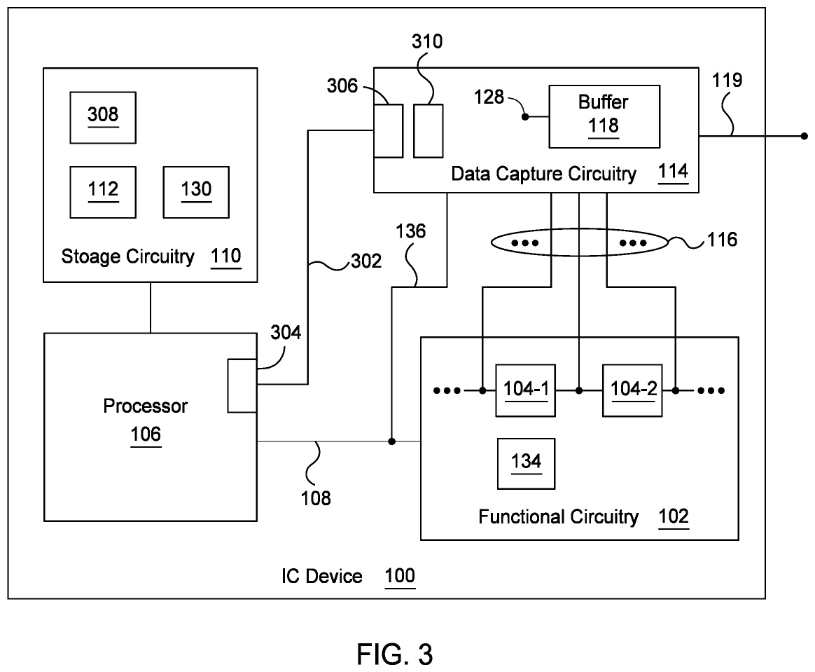

FIG. 3 is a block diagram of IC device 100, further including a communication path 302 between processor 106 and data capture circuitry 114, according to an embodiment. Processor 106 may communicate with data capture circuitry 114 over communication path 302 based on another embedded computer program referred to herein as a driver 308.

In the example of FIG. 3, processor 106 and data capture circuitry 114 include respective interface circuitry 304 and 306. Interface circuitry 304 and 306 may include respective master and slave interface circuitry, which may operate in accordance with an AXI protocol.

In an embodiment, interface circuitry 304 and 306 represent or include an AXI debug hub that interfaces between processor 106 and an ILA core of data capture circuitry 114. In this embodiment, data capture circuitry 114 may further include a driver 310 that permits processor 106 to control and monitor operation of the ILA core, examples of which are provided further below.

Processor 106 may initiate trigger 128 directly or indirectly. In FIG. 1, 2, or, processor 106 may initiate trigger 128 indirectly by asserting a predetermined value over communication path 108. In this example, data capture circuitry 114 monitors communication path 108 over a link 136, and outputs the contents of buffer 118 when it detects the predetermined value. Processor 106 may provide the predetermined value in an address field of a memory access request (e.g., a read or write request). Functional circuitry 102 may include a register 134 dedicated to data capture, and the predetermined value may correspond to an address of register 134. Data capture circuitry 114 may disregard or ignore a data field of the memory access request.

In FIG. 3, processor 106 may directly initiate trigger 128 over communication path 302. In this embodiment, processor 106 may initiate trigger 128 by sending a control or a command/interrupt to data capture circuitry 114 over communication path 302. Processor 106 may use an application programming interface (API) of driver 308 to initiate trigger 128. Processor 106 may also use the API of driver 308 to monitor one or more operations of data capture circuitry 114 and/or to configure data capture circuitry 114 to output contents of buffer 118 based on a state of one or more monitored signals of functional circuitry 102.

In an embodiment, processor 106 evaluates one or more internal signals/data of functional circuitry for correctness. The internal signals/data monitored by processor 106 may include internal signals/data captured by data capture circuitry 114 and/or other internal signals/data of functional circuitry 102. Processor may receive the internal signals/data from functional circuitry 102 and/or from data capture circuitry 114 over communication path 302. Processor 106 may compare the internal signals/data of functional circuitry 102 to expected data. Processor 106 may determine the expected data based on signals/data previously provided to functional circuitry 102 by processor 106. Processor may initiate trigger 128 when the received data does not match the expected data.

Alternatively, or additionally, processor 106 may initiate trigger 128 based on a condition of functional computer program 112. Processor 106 may, for example. initiate trigger 128 at a selectable break-point of functional computer program 112 (i.e., at a selectable line(s) of instructions/code of functional computer program 112). This may be useful to output a state of functional circuitry 102 the corresponds to a point of interest of functional computer program 112. Trigger computer program 130 may include code/instructions to insert instructions into functional computer program 112 at a desired breakpoint, where the inserted instructions cause processor 106 to initiate trigger 128. The inserted instructions may cause processor 106 to use the API of driver 308 to initiate trigger 128.

As described above, trigger computer program 130 includes instructions to cause processor 106 to initiate trigger 128. Trigger computer program 130 may further include instructions for tracing and/or altering execution of functional computer program 112. Trigger computer program 130 may further include instructions to permit a user to monitor and modify internal variables of functional computer program 112, and/or to call functions independent of an operational behavior of functional computer program 112. Trigger computer program 130 may include debugger instructions/code analogous to a conventional debugger, such as a GNU debugger (GDB) maintained by the GDB Steering Committee.

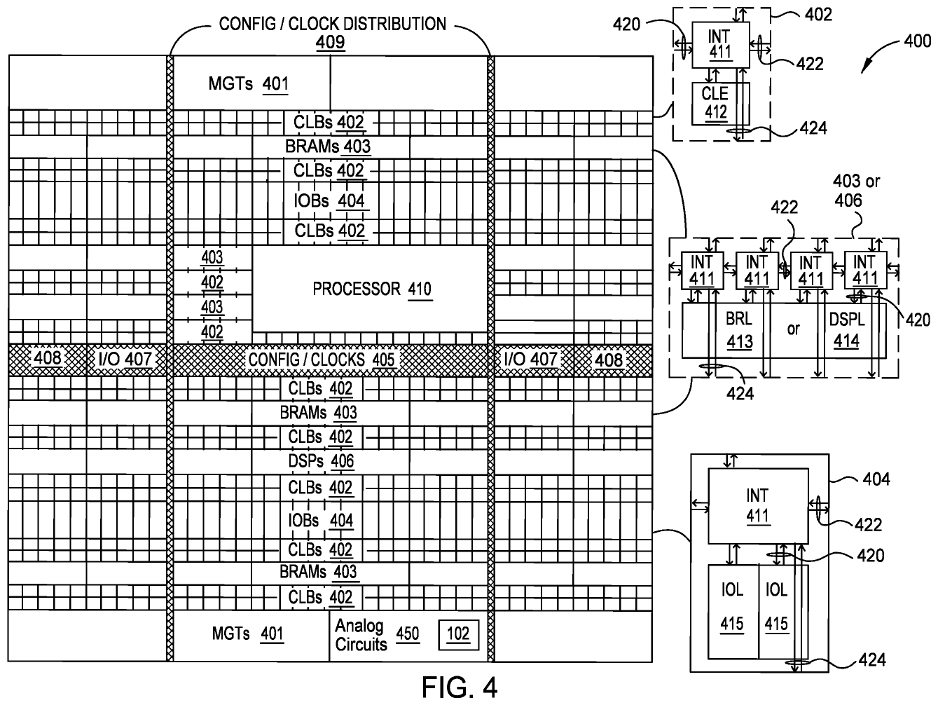

In FIG. 2, PL 202 may include one or more of a variety of types of configurable circuit blocks, such as described below with reference to FIG. 4. FIG. 4 is a block diagram of PL 400, including an array of configurable or programmable circuit blocks or tiles, according to an embodiment. The example of FIG. 4 may represent a field programmable gate array (FPGA) and/or other IC device(s) that utilizes configurable interconnect structures for selectively coupling circuitry/logic elements, such as complex programmable logic devices (CPLDs).

In the example of FIG. 4, the tiles include multi-gigabit transceivers (MGTs) 401, configurable logic blocks (CLBs) 402, block random access memory (BRAM) 403, input/output blocks (IOBs) 404, configuration and clocking logic (Config/Clocks) 405, digital signal processing (DSP) blocks 406, specialized input/output blocks (I/O) 407 (e.g., configuration ports and clock ports), and other programmable logic 408, which may include, without limitation, digital clock managers, analog-to-digital converters, and/or system monitoring logic. The tiles further includes a dedicated processor 410.

One or more tiles may include a programmable interconnect element (INT) 411 having connections to input and output terminals 420 of a programmable logic element within the same tile and/or to one or more other tiles. A programmable INT 411 may include connections to interconnect segments 422 of another programmable INT 411 in the same tile and/or another tile(s). A programmable INT 411 may include connections to interconnect segments 424 of general routing resources between logic blocks (not shown). The general routing resources may include routing channels between logic blocks (not shown) including tracks of interconnect segments (e.g., interconnect segments 424) and switch blocks (not shown) for connecting interconnect segments. Interconnect segments of general routing resources (e.g., interconnect segments 424) may span one or more logic blocks. Programmable INTs 411, in combination with general routing resources, may represent a programmable interconnect structure.

A CLB 402 may include a configurable logic element (CLE) 412 that can be programmed to implement user logic. A CLB 402 may also include a programmable INT 411.

A BRAM 403 may include a BRAM logic element (BRL) 413 and one or more programmable INTs 411. A number of interconnect elements included in a tile may depends on a height of the tile. A BRAM 403 may, for example, have a height of five CLBs 402. Other numbers (e.g., four) may also be used.

A DSP block 406 may include a DSP logic element (DSPL) 414 in addition to one or more programmable INTs 411. An IOB 404 may include, for example, two instances of an input/output logic element (IOL) 415 in addition to one or more instances of a programmable INT 411. An I/O pad connected to, for example, an I/O logic element 415, is not necessarily confined to an area of the I/O logic element 415.

In the example of FIG. 4, config/clocks 405 may be used for configuration, clock, and/or other control logic. Vertical columns 409 may be used to distribute clocks and/or configuration signals.

A logic block (e.g., programmable of fixed-function) may disrupt a columnar structure of PL 400. For example, processor 410 spans several columns of CLBs 402 and BRAMs 403. Processor 410 may include one or more of a variety of components such as, without limitation, a single microprocessor to a complete programmable processing system of microprocessor(s), memory controllers, and/or peripherals.

In FIG. 4, PL 400 further includes analog circuits 450, which may include, without limitation, one or more analog switches 47, multiplexers, and/or de-multiplexers. Analog switches 47 may be useful to reduce leakage current.

FIG. 4 is provided for illustrative purposes. PL 400 is not limited to numbers of logic blocks in a row, relative widths of the rows, numbers and orderings of rows, types of logic blocks included in the rows, relative sizes of the logic blocks, illustrated interconnect/logic implementations, or other example features of FIG. 4.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC) device, comprising:
functional circuitry;
a processor configured to interact with the functional circuitry over a first communication path based on a computer program and to initiate a trigger; and
data capture circuitry configured to store a state of the functional circuitry in a buffer, and to output contents of the buffer to an external device based on the trigger.

2. The IC device of claim 1, wherein the processor is further configured to initiate the trigger at a selectable breakpoint of the computer program.

3. The IC device of claim 1, wherein the processor is further configured to initiate the trigger based on data generated by the functional circuitry.

4. The IC device of claim 3, wherein the processor is further configured to evaluate the data generated by the functional circuitry for correctness, and to initiate the trigger based on the evaluation.

5. The IC device of claim 1, wherein the processor is further configured to output states of variables managed by the processor to the external device when the processor initiates the trigger.

6. The IC device of claim 1, wherein:
the processor is further configured to initiate the trigger by asserting a predetermined value on the first communication path; and
the data capture circuitry is further configured to monitor the first communication path for the predetermined value.

7. The IC device of claim 6, wherein:
the processor is further configured to assert the predetermined value in an address field of a memory access request.

8. The IC device of claim 6, wherein:
the functional circuitry comprises a register; and
the predetermined value corresponds to an address of the register.

9. The IC device of claim 1, further comprising:
a second communication path between the data capture circuitry and the processor;
wherein the processor is further configured to initiate the trigger over the second communication path.

10. The IC device of claim 9, wherein:
the processor and the data capture circuitry comprise respective master and slave interface circuitry configured to communicate with one another over the second communication path.

11. The IC device of claim 9, wherein:
the processor and the data capture circuitry comprise respective first and second drivers configured to permit the processor and the data capture circuitry to communicate with one another over the second communication path; and
the processor is further configured to monitor and control the data capture circuitry through an application programming interface (API) of the first driver.

12. The IC device of claim 11, wherein the processor is further configured to control the data capture circuitry by configuring the data capture circuitry to output the contents of the buffer based on a selectable state of the functional circuitry.

13. An integrated circuit (IC) device, comprising:
functional circuitry;
a processor configured to interact with the functional circuitry over a first communication path based on a computer program, initiate a trigger, and output states of variables managed by the processor to an external device at a selectable breakpoint of the computer program; and
data capture circuitry configured to store a state of the functional circuitry in a buffer, and to output contents of the buffer to the external device based on the trigger.

14. The IC device of claim 13, further comprising:
a second communication path between the data capture circuitry and the processor;
wherein the processor is further configured to initiate the trigger over the second communication path.

15. The IC device of claim 13, wherein:
the processor is further configured to initiate the trigger by asserting a predetermined value on the first communication path; and
the data capture circuitry is further configured to monitor the first communication path for the predetermined value.

16. An integrated circuit (IC) device, comprising:
programmable logic, comprising functional circuitry and data capture circuitry configured to store a state of the functional circuitry in a buffer and to output contents of the buffer to an external device based on a trigger; and
a processor configured to interact with the functional circuitry over a first communication path based on a computer program, and to initiate the trigger.

17. The IC device of claim 16, wherein the processor is further configured to initiate the trigger at a selectable breakpoint of the computer program.

18. The IC device of claim 16, wherein the processor is further configured to initiate the trigger based on data generated by the functional circuitry.

19. The IC device of claim 16, wherein:
the processor is further configured to initiate the trigger by asserting a predetermined value on the first communication path; and
the data capture circuitry is further configured to monitor the first communication path for the predetermined value.

20. The IC device of claim 16, further comprising:
a second communication path between the data capture circuitry and the processor;
wherein the processor is further configured to initiate the trigger over the second communication path.
